(19) United States
(12) Patent Application Publication
(10) Pub. No.: US 2021/0187917 A1
(43) Pub. Date: Jun. 24, 2021

(54) CHEMICAL AND FLAME RETARDANT FABRIC SEAM TAPES

(71) Applicant: ANSELL MICROGARD LIMITED, East Yorkshire (GB)

(72) Inventors: Zhimin ZHU, Hangzhou (CN); Michael DRAPER, York (GB); Jing LIU, Fenghuang Town (CN)

(21) Appl. No.: 16/755,837

(22) PCT Filed: Oct. 15, 2018
(86) PCT No.: PCT/CN2018/110218

§ 371 Date: Apr. 13, 2020

Related U.S. Application Data
(60) Provisional application No. 62/571,972, filed on Oct. 13, 2017.

(51) Int. Cl. B32B 27/08; B32B 27/32; B32B 27/40; B32B 27/30; B32B 7/12

(52) U.S. Cl. CPC B32B 27/08; B32B 27/32; B32B 27/40; B32B 27/306; B32B 27/304; B32B 2571/00; B32B 2307/714; B32B 2307/3065; B32B 2250/05; B32B 2250/24; B32B 7/12

(57) ABSTRACT

A chemical and flame retardant fabric seam tape that includes at least first and second polymer film layers, the first polymeric film layer comprising a single layer polymer film of poly (vinyl chloride), and the second polymer film layer comprises poly (vinyl chloride); and a co-extruded polymer film comprising an ethylene vinyl alcohol layer, disposed between the first polymeric film and the second polymeric film; and wherein the bonded areas have been formed by thermal bonding using heat and pressure and a polyurethane adhesive disposed between the first polymer film layer and the co-extruded polymer film and a flame-retardant polyurethane adhesive disposed between the second polymer film layer and the co-extruded polymer film layer.

### BACKGROUND

### Field of the Invention

The present invention relates to fabrics and, more particularly, to chemical and flame retardant tapes for joining fabrics.

### Description of the Related Art

Fabrics that protect against chemicals may be used within personal protective equipment (PPE), such as apparel for use in industrial, military or civil defense, i.e., police and firefighting departments. Other applications include fabrics for the chemical protection of equipment or for the manufacture of tent components or temporary shelters. The materials from which such protective apparel are made may consist of a single layer of film (or multiple layers of films, e.g., multi-layer laminates) either used alone or in combination with other layers such as woven or non-woven fabrics. The film layers used in the manufacture of protective apparel materials provide protection to the wearer against hazardous chemicals by ensuring a low rate of molecular permeation across the two opposing faces of the materials forming the outer surface and inner surface of the PPE. The fabrics to make PPE and other articles are often cut and sewn, indicating that seams are part of the designs. Seams are often a weak point of PPE and articles, both physical properties, such as abrasion resistance and tensile strength as well as chemical permeation.

The permeation of a particular chemical or mixture of chemicals across the opposing faces of multi-layer laminates can be measured using standard test methods to determine the effectiveness of the barrier properties of the film or laminate(s) being tested. One standard test method is ISO 6529:2013 “Protective clothing—Protection against chemicals—Determination of resistance of protective clothing materials to permeation by liquids and gases.” This test method can be used for any chemical identified as a potential hazard which may be anticipated in a particular environment or, alternatively, may be used for a standard range of chemicals such as that identified in Annex A (parts A2 and A3) of ISO 6529:2013 or ASTM F1001-12 (2017) “Standard guide for selection of chemicals to evaluate protective clothing materials.”

Materials currently available for use as chemical barrier sheets or films for PPE include polyethylene, natural or synthetic rubbers, and polyurethane. These materials are limited in that these are either prone to chemical degradation (e.g., polyurethane), have poor resistance to chemical permeation through the film layer (e.g., polyethylene) or both. The flexibility of these materials having multiple layers decreases as the number of film layers increases. The inflexibility of articles made with these materials is further exacerbated by thick seam tapes.

Chemical and flame retardant fabric seam tapes are provided herein.

### SUMMARY

Embodiments of the disclosure comprise seam tapes for use in joining chemical and flame retardant fabrics, substantially as shown in and/or described in connection with at least one of the figures, as set forth more completely in the claims, are disclosed. Various advantages, aspects, and novel features of the present disclosure will be more fully understood from the following description and drawings.

The foregoing summary is not intended, and should not be contemplated, to describe each embodiment or every implementation of embodiments of the present disclosure. The Detailed Description and Figures more particularly exemplify embodiments of the present disclosure.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only illustrative embodiments of this disclosure and are therefore not to be considered limiting of its scope, for the disclosure may admit to other equally effective embodiments.

From the disclosure and the following more detailed description of various embodiments it will be apparent to those skilled in the art that the chemical and flame retardant fabrics provide a significant advance in the technology of making PPE and other protective articles. Those skilled in the art, i.e., those having knowledge or experience in this area of technology, will recognize that many uses and design variations are possible for the making of fabrics disclosed herein. The following detailed discussion of various alternative features and embodiments will illustrate the general principles of the invention. Particularly significant are methods and chemical and flame retardant fabrics and articles made pursuant thereto. Additional features and advantages of various embodiments will be better understood in view of the detailed description provided below.

FIG. 1 is a schematic representation of a polymer film layer, according to embodiments of the disclosure;

FIG. 2 is a schematic representation of a first co-extruded multilayer polymer film, according to embodiments of the disclosure;

FIG. 3 is a schematic representation of a chemical and flame retardant fabric seam tape comprising two layers of the polymer film layer of FIG. 1 laminated with the co-extruded multilayer polymer film of FIG. 2, according to embodiments of the disclosure;

FIG. 4A comprises schematic representations of a first calendar bonding unit and FIG. 4B comprises a second calendar bonding unit for a laminating apparatus suitable for forming a chemical and flame retardant fabric seam tape, according to embodiments of the disclosure; and

FIG. 5 is a schematic representation of a chemical and flame retardant fabric seam tape comprising two layers of the polymer film layer of FIG. 1 laminated with the co-extruded multilayer polymer film, according to embodiments of the disclosure.

### DETAILED DESCRIPTION

Before describing embodiments of the present disclosure in detail, the terminology used herein is for the purpose of describing particular embodiments only, and is not intended to be limiting. Embodiments should not necessarily be limited to specific compositions, materials, sizes, designs or equipment, as such may vary within the scope of the disclosure. All technical and scientific terms used herein have the usual meaning conventionally understood by persons skilled in the art to which this disclosure pertains, unless context defines otherwise.

As will be described more fully below, the chemical and flame retardant fabric seam tapes in accordance with the present disclosure may comprise a first polymer layer and a second polymer layer, such as a poly(vinyl chloride) polymer film. The first polymer layer and a second polymer layer may be of the same polymer film. Alternatively, some embodiments comprise wherein the first polymer layer and a second polymer layer are different polymer films. A third layer, disposed between the first polymer layer and the second polymer layer, may comprise a multi-layer film. Some embodiments of the disclosure comprise a multi-layer film having two polypropylene layers adhered to each other and having an ethylene vinyl alcohol layer disposed therebetween. The ethylene vinyl alcohol film is, optionally, a hydrolysed vinyl acetate ethylene polymer (usually referred to as ethylene vinyl alcohol or EVOH) ranging from approximately 3-8 microns in thickness and in at least some exemplary embodiments, approximately 4-5 microns in thickness, co-extruded with first and second outer layers of the polypropylene layers. The multi-layer film is bonded to the first and second outer layers by use of a thin adhesive layer, typically approximately 1 micron to 4 microns thick. In some exemplary embodiments, the thin adhesive layer comprises a flame-retardant polyurethane. The outer layers of polypropylene polymer film or copolymer film in the multi-layer laminate are approximately 8-10 microns to approximately 13-18 microns in thickness.

According to embodiments of the disclosure, the chemical and flame retardant fabric seam tapes may join or seal a protective garment produced from any of the chemical and flame retardant fabrics and/or by any of the methods described herein. These protective garments, and other embodiments herein disclosed or within the scope of the embodiments, may include, for example, suits, gloves, drapes, etc. Furthermore, according to embodiments of the disclosure, non-apparel articles may include, for example, chemical barrier tarpaulins, bags, tents, shelters, evacuation bags or casualty bags. In embodiments, seam tape of the present disclosure, disposed atop a fabric seam, decreases the permeability of the fabric and/or seam thereof to liquid and gaseous chemicals.

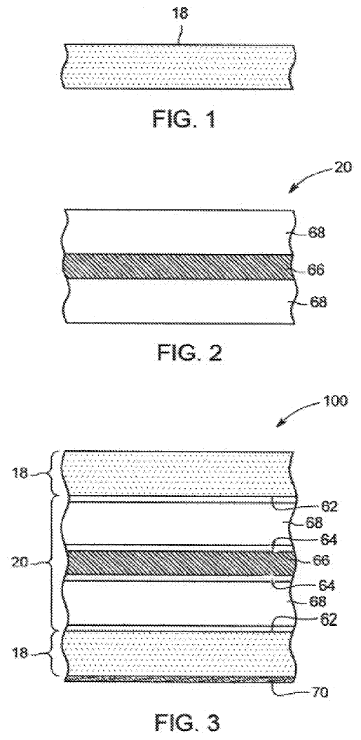

FIG. 1 is a schematic representation of a polymer film layer 18, according to embodiments of the disclosure. The polymer film layer 18 may be a single layer of polymer or a co-extruded polymer film. As depicted, the polymer film layer 18 is a single polymer film layer having a thickness of approximately 63.5+/−3.5 microns and a 84 g/m² basis weight+/−7 g/m². The polymer film layer 18 may comprise any flame-retardant polymer. At least one exemplary embodiment includes a polymer film layer 18 comprising a poly (vinyl chloride) material. In some embodiments according to the disclosure, the polymer film layer 18 comprises, for example, poly (vinylidene chloride) material. In some embodiments, the chemical and flame retardant fabric seam tape in accordance with the present disclosure includes at least a first polymer film layer 18 and a second polymer film layer 18. In embodiments, the first polymeric film layer 18 comprises or consists of a single layer polymer film of poly (vinyl chloride), and the second polymer film layer 18 comprises or consists of poly (vinyl chloride). In embodiments, the polymer film layer 18 may comprise different coloring or may be clear. In some embodiments, the polymer film layer 18 is a copolymer of poly (vinyl chloride) and poly (vinylidene chloride) represented by the formula below, where x represents a number of vinylidene units in a polymer backbone chain and y represents a number of vinyl units in a polymer backbone chain:

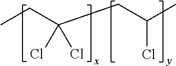

FIG. 2 is a schematic representation of a first co-extruded multilayer polymer film 20, according to embodiments of the disclosure. In embodiments, at least one multi-layer polymer film comprises two polypropylene layers 68 and an ethylene vinyl alcohol layer 66 disposed therebetween. For example a first and second polypropylene layer 68 may be in contact with a first and second side of an ethylene vinyl alcohol layer 68. In some embodiments of the disclosure a first co-extruded multilayer polymer film 20 comprises or consists of a multi-layer polymer film having two polypropylene layers 68 and an ethylene vinyl alcohol layer 66 disposed therebetween having a 37.7 g/m² basis weight, +/−3 g/m². The multi-layer polymer film polypropylene layers 68 have a thickness from approximately 14 to 18 microns each. The ethylene vinyl alcohol layer 66 is, optionally, a hydrolysed vinyl acetate ethylene polymer (usually referred to as ethylene vinyl alcohol or EVOH). The EVOH layer 66 is typically 4-8 microns in thickness and co-extruded with a first polypropylene layer 68 and a second polypropylene layer 68. In embodiments, the chemical and flame retardant fabric seam tape of the present disclosure includes a co-extruded film 20 including two polypropylene layers 68 such as polypropylene films enveloping an ethylene vinyl alcohol layer 66. In some embodiments, the chemical and flame retardant fabric seam tape of the present disclosure includes two polypropylene copolymer layers 68 such as films enveloping the ethylene vinyl alcohol layer 66. Embodiments of the disclosure include wherein the polypropylene layer 68 is a co-extruded film comprising at least one polypropylene copolymer film. In some exemplary embodiments, the polypropylene copolymer film is a polypropylene-polyethylene block copolymer. In some embodiments, the chemical and flame retardant fabric seam tape of the present disclosure includes a co-extruded film 20 bonded by adhesive tie layers 64 as shown in FIG. 3. In embodiments, the first and second polypropylene layers 68 are adhered to the EVOH layer 66 by use of a tie layer 64, typically approximately 1 micron to 4 microns thick, or in embodiments, the adhesive tie layers are approximately 2-3 microns thick. In embodiments, the tie layer 64 comprises, for example, a polyethylene polymer having a maleic anhydride functional group on a backbone of the polyethylene polymer chains. In some exemplary embodiments, the tie layer 64 comprises a modified polyethylene, for example, a polyethylene material having maleic anhydride moieties grafted thereon. In embodiments, as shown in FIG. 3, a first tie layer 64 and a second tie layer 64 may comprise a resin or thermoplastic suitable for binding first and second polypropylene layers 68 to the EVOH layer 66.

FIG. 3 is a schematic representation of a chemical and flame retardant fabric seam tape 100 comprising two layers of the polymer film 18 of FIG. 1 laminated with the co-extruded multilayer polymer film 20 of FIG. 2, according to embodiments of the disclosure. Exemplary embodiments of the chemical and flame retardant fabric seam tape 100 range in thickness from approximately 180-200 microns and approximately a 250 g/m² basis weight. The upper polymer film 18 is a poly (vinyl chloride) layer having a thickness of approximately 63.5 microns. The lower polymer film 18 is a poly (vinyl chloride) layer having a thickness of approximately 63.5 microns (before polyurethane glue 70 is added). The multi-layer polymer film 20 comprising two layers of polypropylene film 68 having an ethylene vinyl alcohol layer 66 therebetween having a thickness of approximately 40 microns. In some embodiments, the two layers of polypropylene film 68 were adhesive bonded to polymer film 18 using flame retardant polyurethane glue 62, which are approximately 10-20 microns in thickness and a basis weight of approximately 4-8 g/m². In at least some exemplary embodiments, the multi-layer polymer film 20 is treated on both sides of the film with a corona treatment. The corona treatment increases the surface energy of the polypropylene and/or polypropylene-polyethylene copolymer films, e.g., first polypropylene layer 68 and a second polypropylene layer 68, which improves the lamination strength and/or allows the adhesives to adhere with greater strength. The chemical and flame retardant fabric seam tape 100 further comprises a polyurethane glue layer 70, having a thickness of approximately 50 microns, disposed on one or more of the layers 18. At least one exemplary embodiment of the chemical and flame retardant fabric seam tape 100 comprises a multi-layer polymer film 20 that is 40 microns in thickness, wherein each polypropylene copolymer layer is approximately 13-18 microns, the EVOH layer is 4-5 microns, and each tie layer is approximately 2-3 microns, each of the layers 18 range in thickness from 63.5 microns +/−3.5 microns.

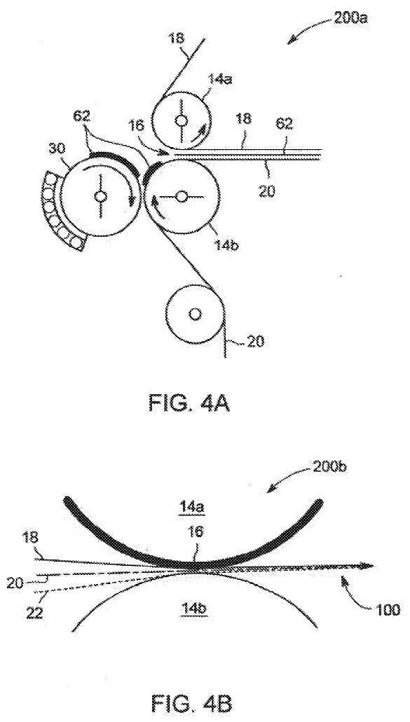

The process conditions to produce the chemical and flame retardant fabric seam tape 100 shown in FIG. 3 were providing pressure between smooth calendar rolls 14a, 14b as discussed above and at a pressure of up to approximately 95 bar and a process speed of approximately 10-30 m/min. Some embodiments of the disclosure comprise laminating the upper polymer film layer 18 and the co-extruded multilayer polymer film 20, wherein the flame retardant polyurethane glue 62 is disposed therebetween, forming a subcomponent of the chemical and flame retardant fabric seam tape 100 by applying pressure using the upper and lower calendar rolls 14a and lower 14b discussed below. The flame-retardant polyurethane glue 62 may be applied using, for example, a glue dosing system. Subsequently, (not shown in FIG. 4A) the lower polymer film layer 18 is laminated with the subcomponent, wherein the flame retardant polyurethane glue 62 is disposed therebetween, again applying using the pressure upper and lower calendar rolls 14a and lower 14b. Finally, the polyurethane glue layer 70 (not shown in FIG. 4A) is applied, forming the chemical and flame retardant fabric seam tape 100. For example, polyurethane glue layer 70 is applied to the outer layer(s) of one or more polymer layers 18. Some embodiments of the disclosure include wherein the upper polymer film layer 18, the lower polymer film layer 18 and the co-extruded multilayer polymer film 20 disposed therebetween are laminated simultaneously. As mentioned above, the chemical and flame retardant fabric seam tape 100 comprises a polyurethane glue such as polyurethane glue layer 70 disposed thereon and is useful as a seam tape to join other fabrics as desired to produce an article of protective apparel.

FIG. 4A comprises schematic representations of a first calendar bonding unit 200a and FIG. 4B relates to a second calendar bonding unit 200b for a laminating apparatus suitable for forming or manufacturing a laminated chemical and flame retardant fabric seam tape 100, according to embodiments of the disclosure. It is to be understood that the flame retardant fabric seam tape 100 has the polyurethane glue layer 70 disposed thereon after the lamination of the layers 18, 20, and 18. Referring to FIG. 4A, there is shown a section of a calendar unit 200a forming part of a laminating apparatus suitable for use in the manufacturing of a chemical and flame retardant barrier fabric seam tape 100 according to the present disclosure. The calendar unit 200a comprises calendar rolls 14a and 14b located adjacent one another, wherein the rolls 14a, 14b provide a nip 16 therebetween. Some embodiments of the disclosure include wherein one of the rolls 14a, 14b is a steel roller and one of the rolls 14a, 14b is a compliant roller, such as a rubber roller. Some embodiments of the disclosure include wherein one of the rolls 14a, 14b is stationary. Some embodiments of the disclosure include wherein the rolls 14a, 14b are rotatable and motor-driven. The point of contact between the calender rolls 14a and 14b provides a nip 16 through which the materials to be bonded are passed. In the chemical and flame retardant fabric seam tape 100 shown in FIG. 3, the materials which form the fabric comprise an upper polymer film layer 18 (not shown), a lower polymer film layer 18 (which may be the same as or different than the upper polymer film layer 18), and a middle layer 20. The calendar unit 200a further comprises roller 30. Some embodiments comprise a roller 30 that is an anilox roller. An anilox roller typically comprises a pattern. Some embodiments include a roller 30 that is smooth. The roller 30 transfers a glue, for example, a hot melted glue or the flame-retardant polyurethane glue 62 to the middle layer 20. The rotation of at least one of the calendar rolls 14a and 14b presses the polymer film 18 and the middle layer 20, adhering them with the flame-retardant polyurethane glue 62. Subsequently, a second polymer layer 18 is adhered to the middle layer 20 and having the flame-retardant polyurethane glue 62 disposed therebetween, similar to as described above. Although not shown, a polyurethane glue layer 70 is then disposed on either the upper polymer layer 18 or the lower polymer layer 18, forming a laminated chemical and flame retardant fabric seam tape 100. Referring to FIG. 4B, there is shown a section of a calendar unit 200b forming part of a laminating apparatus suitable for use in the manufacturing of a chemical barrier fabric 100 according to the present disclosure. This calendar unit 200b comprises rotatable motor-driven upper and lower calendar rolls 14a and lower 14b located adjacent one another, wherein the rolls 14a, 14b contact each other when no material is provided therebetween. Some embodiments of the disclosure include wherein one of the rolls 14a, 14b is a steel roller and one of the rolls 14a, 14b is a compliant roller, such as a rubber roller. Some embodiments of the disclosure include wherein one of the rolls 14a, 14b is stationary. The point of contact between the calendar rolls 14a and 14b provides a nip 16 through which the materials to be bonded are passed. In the chemical and flame retardant fabric 100 shown in FIG. 3, the materials which form the fabric comprise an upper polymer film layer 18, a lower polymer film layer 18 (which may be the same as or different than the upper polymer film layer 18), and a middle layer 20.

Alternatively, some embodiments of the disclosure include a layer 22. The layer 22 may replace, for example, the lower polymer film 18 of the chemical and flame retardant fabric seam tape 100, as described above. Some embodiments include a layer 22 being laminated with the chemical and flame retardant fabric seam tape 100. The layers 18, 20, 22 are generally supplied in a roll, and are unwound and simultaneously passed between the rotating upper 14a and lower 14b calender rolls. In some embodiments of the disclosure, the rotating upper 14a and lower 14b calender rolls are optionally heated. The layer 22 may be thermally bonded at the nip 16 where the upper calender roll 14a compress the materials against the smooth surface of the lower calender roll 14b. The heat of the calender rolls 14a and 14b softens the material of each of the layers 18, 20, 22 and the application of pressure applied therebetween, causing the materials of the layers 18, 20, 22 to melt and creating a laminate of the layers 18, 20 and 22 by the thermal bonding process described above and including a flame retardant polyurethane glue 62 disposed at the two interfaces between the layers 18, 20. After the layers 18, 20, and 22 are laminated with one another via thermal bonding, and/or with a polyurethane glue, the resulting multi-layer material may be coated or otherwise have a further external layer applied, such as the polyurethane adhesive 70, which is optionally a flame retardant polyurethane adhesive as described above, to one or both of the layers 18, 22, forming the chemical and flame retardant fabric seam tape 100.

The two calender rolls 14a and 14b are held apart by the materials being bonded, to an extent dependent primarily on the thickness of the materials and the set pressure. Heating of both the upper 14a and lower 14b calender rolls is achieved by thermostatically regulating the temperature of oil passing through each calender roll. The calender rolls 14a and 14b are heated to temperatures which are dependent upon the melting point of the materials being laminated. For example, if the materials comprise polypropylene, which has a melting point of approximately 165° C., the oil of the upper calender roll 14a is typically maintained at a temperature of approximately 160° C., and the oil of the lower calender roll 14b is maintained at a temperature of approximately 155° C. These oil temperatures provide temperatures at the calender roll surfaces within the softening range of polypropylene and sufficient for melting and thereby bonding the layers between the calender rolls 14a, 14b under pressure.

It will be appreciated by the skilled person that the pressure applied by the calender rolls 14a and 14b to the materials can be varied, along with the speed of rotation of the calender rolls. The calender roll speed determines the amount of time the materials, i.e., layers 18, 20, 22 are subject to the pressure and heat at the nip 16. Accordingly, the speed of the calender rolls 14a and 14b is set to ensure that adequate contact time and pressure is given for the glue bonding to occur.

The chemical and flame retardant fabric seam tape 100, according to embodiments of the disclosure, may be joined to many differing fabrics, for example, by using an adhesive. Some embodiments comprise a non-flame retardant glue, including non-flame-retardant polyurethane glue(s) 70. At least one suitable adhesive comprises a flame-retardant polyurethane glue. Exemplary embodiments comprise joining the laminated chemical and flame retardant fabric seam tape 100 to a thermally calendared chemical and flame retardant fabric comprising an outer poly (vinyl chloride) layer disposed on a first surface of a middle layer comprising two coextruded layers of polypropylene films having an ethylene vinyl alcohol layer therebetween (having polyurethane glue, which may or may not be flame retardant), and a flame retardant spunlace or spunbonded polyester and/or wood pulp layer adhered to a second surface of the middle layer, which is opposite the first surface. The thermally calendared chemical and flame retardant fabric may further comprise a flame retardant glue, such as an acrylic flame retardant glue. The non-flame retardant polyurethane glue 70 (as described above), may be used and disposed between the poly (vinyl chloride) layer and the middle layer and the middle layer and the flame retardant spunlace or spunbonded polyester and/or wood pulp layer. As above, the polypropylene films may be corona treated.

Also, some embodiments contemplated herein further comprise joining a fabric comprising a spunlace or spun bonded polypropylene layer (not shown) with the laminated chemical and flame retardant fabric seam tape 100, as described above. At least some exemplary embodiments comprise joining the laminated chemical and flame retardant fabric seam tape 100 to a polypropylene copolymer layer disposed on a first surface of a middle layer comprising two coextruded layers of polypropylene films having an ethylene vinyl alcohol layer therebetween (having polyurethane glue, which may or may not be flame retardant), and a spunlace or spunbonded polypropylene layer adhered to a second surface of the middle layer, which is opposite the first surface. The spunlace or spunbonded layer comprises a polymer, e.g., a spunbonded polypropylene, comprising a mixture of fibers including, in some embodiments, thermo-fusible fibers to form a permanent bond made by heating and pressure or ultrasonic bonding, to the adjacent film surface. For example, carded or hydro-entangled nonwoven fabrics, which may be composed either of 100% polypropylene fibers or a mixture of fibers such as 85% rayon or viscose fibers and 15% polypropylene fibers, may be considered suitable for the spunlace or spunbonded layer. The spunlace or spunbonded layer provides strength to the fabric. Permanent thermal bonds, when subjected to the appropriate temperature and pressure conditions during the coextrusion or laminating process may be formed. The process conditions to produce the chemical and flame retardant fabric seam tape 100 shown in FIG. 3 were calender heating temperatures of approximately 158° C. to 162° C. for smooth calender rolls 14a, 14b as discussed above and at a pressure of up to approximately 95 bar and a process speed of approximately 10-30 m/min. Alternatively, the calender rolls 14a, 14b may comprise projections for providing a point-bonding of the layer 22 with the laminated chemical and flame retardant fabric seam tape 100. As mentioned above, the chemical and flame retardant fabric seam tape 100 is useful as a seam tape to join other fabrics as desired to produce an article of protective apparel.

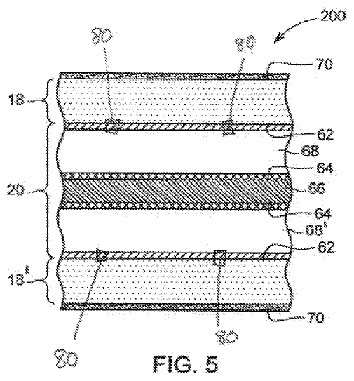

Referring now to FIG. 5, a chemical and flame retardant fabric seam tape of the present disclosure is shown. In embodiments, a chemical and flame retardant fabric seam tape includes a first polymer film layer 18 and a second polymer film layer 18, the first polymeric film layer 18 including (vinyl chloride). In some embodiments, a second polymer film layer 18′ comprises (vinyl chloride) or another polymer. In embodiments, a multi-layered polymer film 20 includes a first polypropylene film 68 and a second polypropylene film 68, wherein an ethylene vinyl alcohol layer 66 is disposed between the first polypropylene film 68 and a second polypropylene film 68′. In embodiments, a first flame-retardant polyurethane adhesive 62 is disposed between the first polymer film layer 18 and the multi-layered polymer film 20 and a second flame-retardant polyurethane adhesive 62 is disposed between the second polymer film layer 18 and the multi-layered polymer film 20, wherein a plurality of bonding areas 80 are disposed between the first polymer film layer 18 and the multi-layered polymer film 20 and the second polymer film 18′ layer and the multi-layered polymer film 20.

Having described particular preferred embodiments of the present disclosure, it is to be appreciated that the embodiments in question are exemplary only, and that variations and modifications such as will occur to those possessed of the appropriate knowledge and skill may be made without departure from the scope of the disclosure as set forth herein. For example, the chemical and flame retardant fabric seam tape is not limited to the number (or composition) of the layers described herein: more chemical barrier layers and/or support layers may be added as required.

Although some embodiments have been discussed above, other implementations and applications are also within the scope of the following claims. The disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the following claims. Also, as used in this specification and the appended claims, the singular forms “a,” “an,” and “the” include plural referents unless the context clearly dictates otherwise. Reference throughout this specification to “some embodiments,” “at least one embodiment,” “one embodiment” or “an embodiment” means that a particular feature, structure, material, step, or characteristic described in connection with the embodiment is included in at least one embodiment of the invention, but do not denote that they are necessarily present in every embodiment. Therefore, the recitation of the phrases “some embodiments,” “at least one embodiment,” “in one embodiment” or “in an embodiment” throughout this specification are not necessarily referring to the same embodiment of the invention. Nonetheless, it is to be understood that any and all features, structures, materials, steps, and/or characteristics may be included in any embodiment except where specifically excluded.

“Optional” or “optionally” means that the subsequently described event or feature may or may not occur or be necessary for any embodiment, or that the subsequently identified material may or may not be present, and that the description includes instances where the event or feature occurs or where the material is present, and instances where the event or feature does not occur or the material is not present. As used herein, the terms “comprises,” “comprising,” “includes,” “including,” “has,” “having,” or any other tense thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

As used herein, throughout the specification and claims, approximating language may be applied to modify any quantitative representation that could permissibly vary without resulting in a change in the basic function to which it is related. Accordingly, a value modified by a term or terms, such as “about” or “approximately,” is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about” or “approximately.”

All ranges recited herein include ranges therebetween, and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4 or more, or 3.1 or more.

1. A chemical and flame retardant fabric seam tape, comprising:
at least a first polymer film layer and a second polymer film layer, the first polymer film layer comprising a single layer polymer film of poly (vinyl chloride), and the second polymer film layer comprising poly (vinyl chloride); and
a co-extruded polymer film comprising an ethylene vinyl alcohol layer disposed between the first polymer film layer and the second polymer film layer, wherein one or more bonded areas are disposed between a flame-retardant polyurethane adhesive disposed between the first polymer film layer and the co-extruded polymer film and a second flame-retardant polyurethane adhesive disposed between the second polymer film layer and the co-extruded polymer film.

2. The chemical and flame retardant fabric seam tape of claim 1, wherein the co-extruded polymer film comprises two polypropylene films enveloping the ethylene vinyl alcohol layer.

3. The chemical and flame retardant fabric seam tape of claim 1, wherein the co-extruded polymer film comprises two polypropylene copolymer films enveloping the ethylene vinyl alcohol layer.

4. The chemical and flame retardant fabric seam tape of claim 1, wherein the co-extruded film is bonded by adhesive tie layers.

5. The chemical and flame retardant fabric seam tape of claim 4, wherein the adhesive tie layers are approximately 2-3 microns thick.

6. The chemical and flame retardant fabric seam tape of claim 2, wherein the two polypropylene films are approximately 14 to approximately 18 microns thick.

7. The chemical and flame retardant fabric seam tape of claim 3, wherein the two polypropylene copolymer films enveloping the ethylene vinyl alcohol layer are approximately 14 to approximately 18 microns thick.

8. The chemical and flame retardant fabric seam tape of claim 1, wherein a polyurethane adhesive is disposed on at least one of the first and second polymer film layers.

9. The chemical and flame retardant fabric seam tape of claim 1, wherein the second polymer film layer comprises a non-poly (vinyl chloride) polymer.

10. A chemical and flame retardant fabric seam tape, comprising:
a first polymer film layer and a second polymer film layer, the first polymer film layer comprising poly (vinyl chloride);
a multi-layered polymer film comprising a first polypropylene film and a second polypropylene film, wherein an ethylene vinyl alcohol layer is disposed between the first polypropylene film and a second polypropylene film; and
a first flame-retardant polyurethane adhesive disposed between the first polymer film layer and the multi-layered polymer film and a second flame-retardant polyurethane adhesive disposed between the second polymer film layer and the multi-layered polymer film, wherein a plurality of bonding areas are disposed between the first polymer film layer and the multi-layered polymer film and the second polymer film layer and the multi-layered polymer film.

11. The chemical and flame retardant fabric seam tape of claim 10, wherein the multi-layered polymer film is characterized as a co-extruded film.

12. A chemical and flame retardant fabric seam tape, comprising:
at least a first polymer film layer and a second polymer film layer, the first polymer film layer comprising a single layer polymer film of poly (vinyl chloride), and the second polymer film layer comprises poly (vinyl chloride); and
a co-extruded polymer film comprising an ethylene vinyl alcohol layer, disposed between the first polymer film layer and the second polymer film layer; and wherein bonded areas have been formed by thermal bonding using heat and pressure and a flame-retardant polyurethane adhesive disposed between the first polymer film layer and the co-extruded polymer film and a flame-retardant polyurethane adhesive disposed between the second polymer film layer and the co-extruded polymer film layer.

13. A method of making a chemical and flame retardant fabric seam tape, comprising: forming the chemical and flame retardant fabric seam tape of claim 1.

14. The chemical and flame retardant fabric seam tape of claim 10, wherein the multi-layered polymer film is bonded by adhesive tie layers.

15. The chemical and flame retardant fabric seam tape of claim 14, wherein the adhesive tie layers are approximately 2-3 microns thick.

16. The chemical and flame retardant fabric seam tape of claim 10, wherein the first polypropylene film and the second polypropylene film are approximately 14 to approximately 18 microns thick.

17. The chemical and flame retardant fabric seam tape of claim 16, wherein the first polypropylene film and the second polypropylene film envelop the ethylene vinyl alcohol layer and are approximately 14 to approximately 18 microns thick.

18. The chemical and flame retardant fabric seam tape of claim 10, wherein a polyurethane adhesive is disposed on at least one of the first and second polymer film layers.

19. The chemical and flame retardant fabric seam tape of claim 10, wherein the second polymer film layer comprises a non-poly (vinyl chloride) polymer.

20. The chemical and flame retardant fabric seam tape of claim 12, wherein a first polypropylene film and a second polypropylene film envelop the ethylene vinyl alcohol layer and are approximately 14 to approximately 18 microns thick.
